(19) United States
(12) Patent Application Publication
(10) Pub. No.: US 2025/0294612 A1
(43) Pub. Date: Sep. 18, 2025

(54) DISTRIBUTED RESOURCE UNIT AND DUAL CLEAR TO SEND IMPLEMENTATION

(71) Applicant: Cisco Technology, Inc., San Jose, CA (US)

(72) Inventors: Brian D. Hart, Sunnyvale, CA (US); Malcolm M. Smith, Richardson, TX (US); Matthew A. Silverman, Shaker Heights, OH (US)

(73) Assignee: Cisco Technology, Inc., San Jose, CA (US)

(21) Appl. No.: 19/080,235

(22) Filed: Mar. 14, 2025

Related U.S. Application Data
(60) Provisional application No. 63/565,301, filed on Mar. 14, 2024.
(60) Provisional application No. 63/759,689, filed on Feb. 18, 2025.

(51) Int. Cl. H04W 74/0816; H04L 5/00; H04W 52/36; H04W 74/00

(52) U.S. Cl. CPC H04W 74/0816; H04L 5/0053; H04W 52/367; H04W 74/002

(57) ABSTRACT

Managing the implementation of Distributed Resource Unit (DRU) and Dual Clear to Send (CTS) may be provided. Managing the implementation of DRU and Dual CTS comprises disallowing one or more DRU techniques for a spectrum that has a regulatory power limitation and signaling that the one or more DRU techniques are disallowed. Managing the implementation of DRU and Dual CTS can also comprise enabling one or more allowed DRU techniques.

### RELATED APPLICATION

Under provisions of 35 U.S.C. § 119 (e), Applicant claims the benefit of and priority to U.S. Provisional Application No. 63/565,301, filed Mar. 14, 2024, and U.S. Provisional Application No. 63/759,689, filed Feb. 18, 2025, the disclosures of which are incorporated herein by reference in its entirety.

### TECHNICAL FIELD

The present disclosure relates generally to managing the implementation of Distributed Resource Unit (DRU) and Dual Clear to Send (CTS).

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for managing the implementation of Distributed Resource Unit (DRU) and Dual Clear to Send (CTS) in accordance with aspects of the present disclosure.

FIG. 2 is a block diagram of a frame with a robust long range preamble in accordance with aspects of the present disclosure.

FIG. 3 is a block diagram of a signal process using DRU and Dual CTS in accordance with aspects of the present disclosure.

FIG. 4 is a flow chart of a method for managing the implementation of DRU in accordance with aspects of the present disclosure.

FIG. 5 is a block diagram of a computing device in accordance with aspects of the present disclosure.

FIG. 6 is a block diagram of a computing device in accordance with aspects of the present disclosure.

### DETAILED DESCRIPTION

### Overview

Managing the implementation of Distributed Resource Unit (DRU) and Dual Clear to Send (CTS) may be provided. Managing the implementation of DRU and Dual CTS comprises disallowing one or more DRU techniques for a spectrum that has a regulatory power limitation and signaling that the one or more DRU techniques are disallowed. Managing the implementation of DRU and Dual CTS can also comprise enabling one or more allowed DRU techniques.

Both the foregoing overview and the following example embodiments are examples and explanatory only and should not be considered to restrict the disclosure's scope, as described, and claimed. Furthermore, features and/or variations may be provided in addition to those described. For example, embodiments of the disclosure may be directed to various feature combinations and sub-combinations described in the example embodiments.

### Example Embodiments

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

A Resource Unit (RU) is a unit in Orthogonal Frequency-Division Multiple Access (OFDMA) denoting a group of tones or subcarriers used in DownLink (DL) and UpLink (UL) transmissions. RUs can be utilized to allocate portions of the available spectrum to different users. A Regular Resource Unit (RRU) is a RU with continuous tones that are adjacent to one another. Thus, a user assigned a RRU will have a defined, uninterrupted frequency range allocated for use. A Distributed Resource Unit (DRU) is a RU with distributed tones spread across the available spectrum. A user assigned a DRU will therefore have multiple distributed portions of the spectrum allocated for use. DRU techniques can be utilized to reduce the likelihood of connection disruptions, otherwise enhance reliability, maximize utilization of the entire available spectrum, and so on.

The Institute of Electrical and Electronics Engineers (IEEE) 802.11bn Ultra High Reliability (UHR) amendment describes modifications to the IEEE standard 802.11 Physical Layer (PHY) and the IEEE 802.11 standard Medium Access Control (MAC). One goal of the IEEE 802.11bn amendment is addressing that Low Power Indoor (LPI)-only clients and other clients that are constrained in some modes, such as by a Power Spectral Density (PSD) regulatory limit, may have limited power available for operation. DRU techniques can be implemented to address the limited power issues of such clients. Given regulations typically limit the transmit power allowed per one Megahertz (MHz). When using DRU, a client ideally transmits at most one OFDM tone per one MHz instead of multiple tones per MHz (e.g., about 12.8 tones per MHz in typical implementations). Devices can therefore use DRU techniques to increase the power of the tones since there is only one tone per one MHz for each device. For example, the single tone of the DRU implementation will have approximately thirteen times the power of an implementation that includes about 12.8 tones per MHz, and the one tone of the DRU implementation will have gains as much as eleven decibels of link budget (i.e., 10*log(12.8)=11 decibels approximately).

Implementing DRU, however, can degrade system throughput and cause other issues. For example, implementing DRU can be wasteful of the available spectrum and can create interference for client devices. Particularly, DRU can be reasonably implemented for many active users but may be wasteful of the available spectrum when there is a low number of users (e.g., one Station (STA), two STAs, or three STAs). When there is a low number of users, each transmission may occupy tenfold or higher additional spectrum than the transmission would otherwise need. Additionally, DRU can cause interference between adjacent co-channel Basic Service Sets (BSSs) since the power of transmission can be tenfold more concentrated at certain frequencies (e.g., roughly thirteen times more concentrated for an implementation that includes about 12.8 tones per MHz).

In a spectrum with regulations that limit PSD, such as the 6 Gigahertz (GHz) spectrum, a STA whose power is thus limited according to the regulations may make decisions related to RRUs differently than for DRUs. For example, STAs may be incentivized to use the spectrum inefficiently, spreading tones widely across the spectrum initially and then increasing Modulation Coding Scheme (MCS) once the tones cannot be spread out any further. When doubling an RU width from RRU with 26-tones (RRU26) to RRU with 52-tones (RRU52), regulations allow double the power. However, the per-subcarrier Signal-to-Noise Ratio (SNR) at the receiving device will be unchanged, so reliability is also unchanged. This also applies to changes to RRU with 106-tones (RRU106), RRU with 242-tones (RRU242), and so on. Thus, an STA will use an entire 20 MHz, 40 MHz, 80 MHz, etc. of bandwidth when and while the STA's Transmit (TX) power is regulatory PSD limited. The STA may therefore reach a maximum bandwidth before increasing the MCS because doubling the bandwidth doesn't reduce range but increasing MCS does.

STAs are also incentivized to use DRU inefficiently when there are regulatory power limits. For DRU with 26-tones (DRU26), the maximum regulatory power comes from one tone per MHz (e.g., spread across more than 26 MHz, such as a maximum possible 40 MHz bandwidth). When doubling to DRU with 52-tones (DRU52), the maximum regulatory power still comes from one tone per MHz (e.g., spread across than 52 MHz, such as a maximum possible 80 MHz bandwidth). Similarly, the maximum regulatory power would be spreading the tones over 160 MHz for DRU with 106-tones (DRU106). Like with RRUs, regulations allow double the power if the RU width is doubled, but the per-subcarrier SNR at the receiving device is unchanged. The reliability is accordingly also unchanged. A STA will therefore use DRU26, DRU52, DRU106, etc. at one tone per MHz, inefficiently resulting in spectral holes.

Additionally, doubling to the next amount DRU tones (e.g., DRU52 to DRU106) does not correspond to doubling the bandwidth, since the max DRU spreading bandwidth will be reached. For example, going from DRU52 to DRU106 provides a somewhat increased power but not twice the power. So, the data rate is doubled with a slightly degraded range. As the data rate is increased, there is a fixed max power across all tones, so doubling the number of tones halves the power per tone. Doubling the number of tones therefore results in doubling the data rate with worse link budget (e.g., a three decibel worse link budget assuming a twenty-nine percent range reduction), until all tones are occupied (e.g., DRU with 996 tones (DRU996)). Only after all tones are occupied will increasing the MCS be considered by a STA based on the regulations, because doubling the number of active tones doubles the data rate at a lower cost than increasing the MCS does (e.g., doubling tones costing three decibels compared to increasing the MCS costing six decibels and only doubling data rate up to sixteen Quadrature Amplitude Modulation (QAM) with less data rate gain thereafter). STAs operating at far range with regulatory power limitations are thus incentivized to use MCSO and DRU52 over 80 MHz of distributed bandwidth.

Management of the implementation of DRU and Dual Clear to Send (CTS) is described herein to address the inefficiencies and problems that DRU can cause when there are regulatory power limits. The preamble of data packets can be designed to be robust enough to support DRU payloads and/or the payloads are sent as part of triggered UL. In triggered UL, the data in the preamble may not need to be correctly received. Additionally, the inefficiency caused from DRU may only be a substantial problem that can cause network issues if a traditional 242 tone DL beacon (e.g., RRU242) works at the same range of the DRU. If an Access Point (AP) beacon at regulatory limit on RRU242 reaches a STA, then the STA can close the link by transmitting at its regulatory limit (e.g., six decibels lower power than the AP at 6 GHZ) via DRU52 over 20 MHz to reach a one antenna AP. The client can increase data rate via DRU242 over 80 MHz for just twenty-five percent spectral inefficiency.

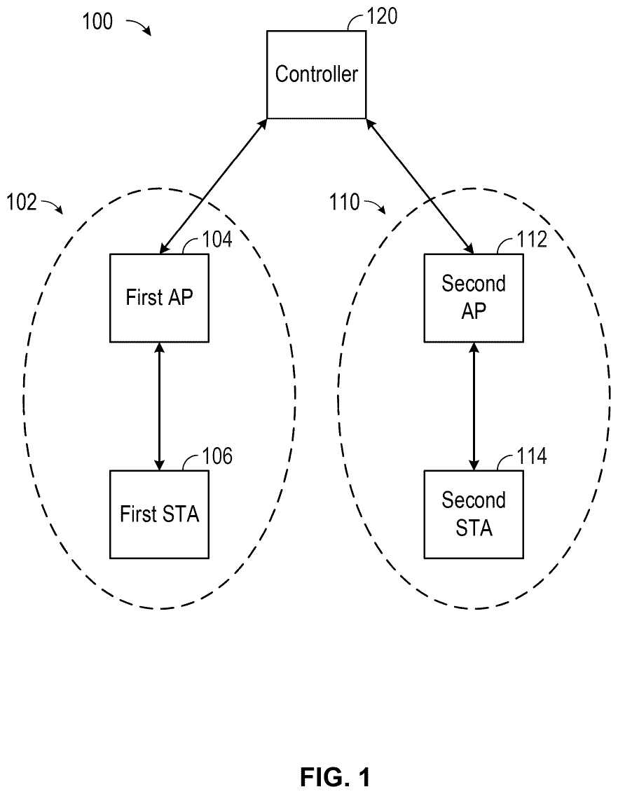

FIG. 1 is a block diagram of an operating environment 100 for managing the implementation of DRU and Dual CTS. The operating environment 100 can include a first BSS 102 comprising a first AP 104 and a first STA 106, a second BSS 110 comprising a second AP 112 and a second STA 114, and a controller 120. The first AP 104 and the second AP 112 may enable devices (e.g., the first STA 106 and the second STA 114), to connect to a network by creating one or more Wireless Local Area Networks (WLANs). The first STA 106 and the second STA 114 can be any device that connects to the network to communicate with other devices on a network, such as a smart phone, a tablet, a personal computer, a server, and/or the like. The controller 120 may be any network controller (e.g., a WLAN controller) and can manage the first AP 104, the second AP 112, and/or other network devices to allow wireless devices to connect to and utilize the network.

The operating environment 100 can include any number of devices in other embodiments, including APs, STAs, controllers, and so on. The operations of the controller 120 may be performed by one or more of the first AP 104 and the second AP 112, whereby there may be no physically separate controller, in some embodiments and vice versa.

In certain embodiments, DRU techniques can be allowed and/or disallowed based on the distance of the STA from the AP. For a spectrum that has regulatory power limits and allows DRU, the data rate strategy can be MCSO with no more than one tone per MHz (e.g., DRU26 in 40 MHZ). As the range decreases, the more DRU can used until there is at least one tone per MHz (e.g., DRU52 in 80 MHZ, DRU106 in 80 MHz). Next, the data rate strategy can change from Binary Phase Shift Keying (BPSK) to Quadrature Phase Shift Keying (QPSK) and/or by doubling the RU size (e.g., MCS1 at DRU106 or MCSO at DRU242 in 80 MHz). As the range further decreases, it is better (e.g., more efficient, produces better network connection, etc.) to prioritize using more tones per RU before selecting a constellation higher than QPSK, such as MCS1 at DRU106, to DRU242, to DRU484, to RRU996 in 80 MHz. The first AP 104, the second AP 112, the controller 120, and/or the like can allow and/or disallow DRU techniques to address inefficiencies that arise from this selection of data rate strategies. Frequency reuse and Non-Primary Channel Access (NPCA) by an Overlapping BSS (OBSS) is more difficult when a neighbor OBSS is using the spectrum inefficiently. Thus, addressing the inefficiencies that arise from the use of DRU techniques can enable more efficient or otherwise successful frequency reuse and NPCA, such as by the first BSS 102 and the second BSS 110 when they are OBSSs.

For a spectrum that is not power limited and disallows DRUs, the data rate strategy can be MCSO at RRU26 at the furthest range with minimum data rate. As the range decreases, the data rate strategy can change from BPSK to QPSK and/or by doubling the RU size. Thus, the data rate strategies can be MSC1 at RRU26 or MSC0 at RRU52. As the range between the devices further decreases, the data rate strategy can be MCS1 at RRU52 or MSC0 at RRU106 in 20 MHz. In certain embodiments, it is better to prioritize using more tones per RU before selecting a constellation higher than QPSK. Thus, the data rate strategy can further change as the rate decreases to MSC1at RRU106, to RRU242 in 20 MHz, to RRU484 in 40 MHz, to RRU996 in 80 MHz.

For a spectrum that is not power limited and allows DRUs, the data rate strategy for different ranges can mirror the spectrum that is not power limited and disallows DRUs, but DRU26, DRU52, DRU106, DRU242, and the like can respectively be used in place RRU26, RRU52, RRU106, RRU242, and the like. For example, the data rate strategy can be MCSO at RRU26 or DRU26 at the furthest range with minimum data rate. The data rate strategy as the range decreases can then be MSC1 at RRU26 or DRU26, or MSC0 at RRU52 or DRU52. Next, MCS1 at RRU52 or DRU52, or MSC0 at RRU106 or DRU106.

For a spectrum that is power limited and disallows DRUs, the data rate strategy can also be MCSO at RRU26 at the furthest range with minimum data rate. As the range decreases, the data rate strategy can be MCSO at RRU52, then RRU106, and then RRU242 in 20 MHz. The data rate strategy can then be MCSO at RRU484 in 40 MHz then RRU996 in 80 MHz as the range further decreases. Finally, the data rate strategy is MSC1 at RRU996 in 80 MHz.

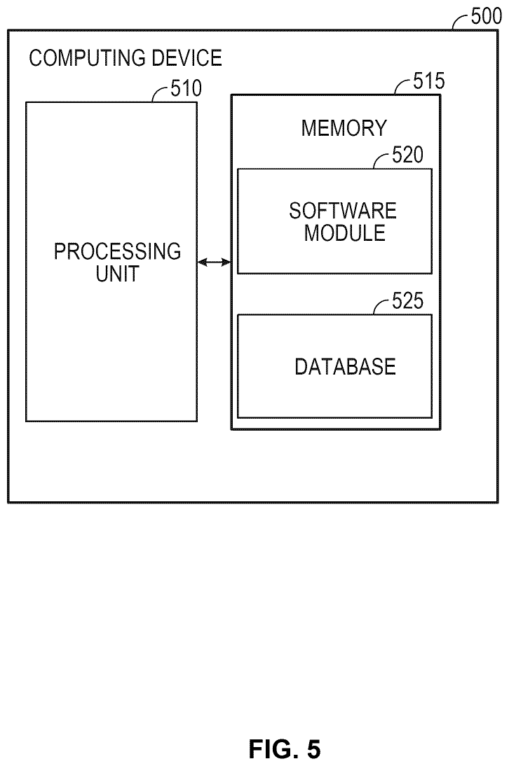

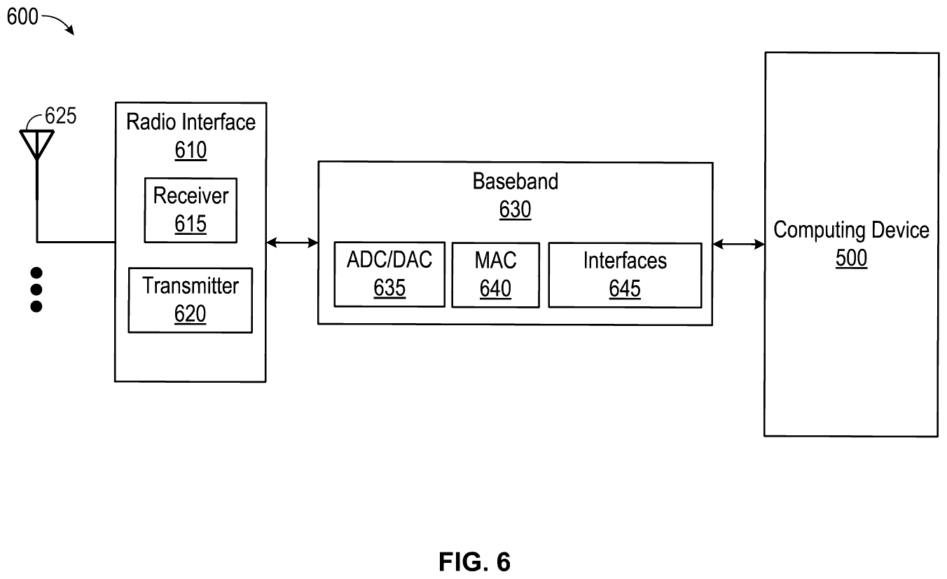

The elements described above of the operating environment 100 (e.g., the first AP 104, the first STA 106, the second AP 112, the second STA 114, the controller 120, etc.) may be practiced in hardware, in software (including firmware, resident software, micro-code, etc.), in a combination of hardware and software, or in any other circuits or systems. The elements of the operating environment 100 may be practiced in electrical circuits comprising discrete electronic elements, packaged or integrated electronic chips containing logic gates (e.g., Application Specific Integrated Circuits (ASIC), Field Programmable Gate Arrays (FPGA), System-On-Chip (SOC), etc.), a circuit utilizing a microprocessor, or on a single chip containing electronic elements or microprocessors. Furthermore, the elements of the operating environment 100 may also be practiced using other technologies capable of performing logical operations such as, for example, AND, OR, and NOT, including but not limited to, mechanical, optical, fluidic, and quantum technologies. As described in greater detail below with respect to FIGS. 5 and 6, the elements of the operating environment 100 may be practiced in a computing device 500 and/or communications device 600.

### Disallowing DRU Techniques to Reduce Inefficiency

As described above, DRU techniques can result in spectral inefficiency when there are regulatory power limits (e.g., PSD limits), such as at 6 GHz. For example, the first STA 106 and the second STA 114 may be incentivized to increasingly spread the DRU tones widely across the spectrum initially until the tones cannot be spread out any further before increasing MCS to transmit at a higher data rate. To minimize or otherwise reduce the spectral inefficiency from DRU on spectrums with regulatory power limits like 6 GHZ, the network devices (e.g., the first AP 104, the first STA 106, the second AP 112, and the second STA 114) can be disallowed from using (i) DRU beacons, (ii) DRU probe requests and probe responses, (iii) DRU Request to Send (RTS), CTS, Multi-User RTS (MU-RTS), Trigger frames, and other control frames, (iv) DRU for DL and/or UL Single User (SU) DRU, and/or (v) OFDMA PHY Protocol Data Units (PPDUs) having a percentage of unoccupied subcarriers within the unpunctured portion of the PPDU bandwidth to be below a threshold. The range of the preamble for frames can also be limited so DRU52 and DRU106 in 80 MHz has essentially the same range as DRU242 and DRU484 in 80 MHz. Alternatively, the range of the preamble for frames can also be limited so DRU52, DRU106, and DRU242 has essentially the same range as DRU484 in 80 MHz.

In some embodiments, the network devices are disallowed from implementing one or more of the DRU techniques because of compliance with standards within their hardware or software and/or other global rules. For example, the IEEE 802.11bn amendment can be revised to disallow network devices from using DRU beacons, DRU probe requests and probe responses, DRU RTS, CTS, MU-RTS, Trigger frames, and other control frames, DL DRU, UL SL DRU, OFDMA PPDU that does not use a minimum percentage of energized tones of a total number of tones transmitted (e.g., an OFDMA PPDU with a percentage of unoccupied subcarriers within the unpunctured portion of the PPDU bandwidth below a threshold), and/or the like.

In other embodiments, APs, in one or more fields respectively in the UHR Operation element for example, can enable and/or disable the various DRU techniques. An AP may enable and/or disable the various DRU techniques specifically for its BSS and unassociated clients attempting to communicate with the AP in example implementations. Thus, the first BSS 102 and the second BSS 110 can have different sets of DRU techniques enabled and disabled according to the signaling of the first AP 104 and the second AP 112, respectively. In certain embodiments, an AP will monitor its BSS to identify whether to allow and/or disallow techniques, such as based on the number of DRU capable clients in the BSS.

In some example implementations, the controller 120 sends to the first AP 104 and the second AP 112 instructions indicating which DRU techniques to enable and which DRU techniques to enable. For example, the controller 120 can monitor the BSSs to identify whether to allow and/or disallow DRU techniques (e.g., based on the number of DRU capable STAs in the respective BSS) and send instructions to the APs based on the monitoring. The first AP 104 and the second AP 112 then signal to the respective clients (e.g., the first AP 104 sends a transmission to the first STA 106 and the second AP 112 sends a transmission to the second STA 114) which DRU techniques are enabled and disabled for the respective BSSs.

The first AP 104 and/or the second AP 112 can limit the range of the preamble so (i) DRU52 and DRU106 in 80 MHz has essentially the same range as DRU242 and DRU484 in 80 MHz or (ii) DRU52, DRU106, and DRU242 has essentially the same range as DRU484 in 80 MHz by sending a control frame to the respective clients. In certain embodiments, the APs can limit the range of the preamble by transmitting a trigger frame with a Universal Signal (USIG) field once and without a power boost.

As described above, using OFDMA PPDU can be disallowed if the OFDMA does not use a minimum percentage of energized tones of a total number of tones transmitted. For example OFDMA PPDUs with unoccupied subcarriers within the unpunctured portion of the PPDU bandwidth that are below a threshold may be disallowed. The threshold can be a percentage of the subcarriers, such as twenty percent, twenty-five percent, thirty percent, fifty percent, and the like. Thus, DRU techniques can be limited based on how inefficient implementing the technique will be.

### Enabling DRU Techniques to Increase Range

DRU techniques can be utilized to maximize or otherwise increase the transmission range of devices when there are regulator power limits (e.g., PSD limits).

To increase the range of devices communicating using spectrums with regulatory power limits like 6 GHZ, the network devices (e.g., the first AP 104, the first STA 106, the second AP 112, and the second STA 114) can be enabled to use (i) DRU for beacons, probe requests, and probe responses, (ii) a robust long range preamble, and/or (iii) DL DRU, SU UL DRU, and/or triggered UL DRU.

In certain embodiments, the network devices are enabled to implement one or more of the DRU techniques because of compliance with standards within their hardware or software and/or other global rules. For example, the IEEE 802.11bn amendment can be revised to enable network devices to use DRU for beacons, DRU for probe requests and probe responses, a robust long range preamble, DL DRU, UL SL DRU, triggered UL DRU, and/or the like. In other embodiments, APs, in one or more fields respectively in the UHR Operation element for example, can enable and/or disable the various DRU techniques as described above. An AP may enable and/or disable the various DRU techniques specifically for its BSS and unassociated clients attempting to communicate with the AP in example implementations. Thus, the first BSS 102 and the second BSS 110 can have different sets of DRU techniques enabled and disabled according to the respective signaling of the first AP 104 and the second AP 112. In some example implementations, the controller 120 sends to the first AP 104 and the second AP 112 instructions indicating which DRU techniques to enable and which DRU techniques to enable, and the first AP 104 and the second AP 112 then signal to the respective clients (e.g., the first AP 104 sends a transmission to the first STA 106 and the second AP 112 sends a transmission to the second STA 114) which DRU techniques are enabled and disabled for the respective BSSs. The APs and/or the controller 120 can determine whether to allow and/or disallow DRU techniques based on monitoring the respective BSSs.

The range of an AP, such as the first AP 104 and the second AP 112, is typically limited by the range of the beacons it sends to advertise availability since the beacons are broadcast without beamforming, at a low MCS, and/or the like. Thus, a STA will not associate or otherwise connect with the AP until in range of the beacons, even if the AP can communicate at increased ranges. Implementing DRU for beacons can increase the range of the beacons and enable STAs to connect to an AP from a greater range, therefore increasing the operating range of an AP. In embodiments, APs are enabled to broadcast beacons using DRU52 over 80 MHz to increase the range of the beacons. The range of an AP can similarly be increased by enabling STAs to send probe requests using DRU and enabling the AP to send probe responses using DRU. In embodiments, the APs and STAs are enabled to send probe requests and probe responses using DRU52 over 80 MHz.

The range of UL and DL transmissions can be increased by enabling DL DRU, SU UL DRU, triggered UL DRU, and/or the like. When enabled, the first AP 104 and the second AP 112 can use DL DRU to increase the range of transmissions to the first STA 106 and the second STA 114 for example. The first STA 106 and the second STA 114 can increase the range of transmissions to the first AP 104 and the second AP 112 using SU UL DRU and/or UL DRU when enabled.

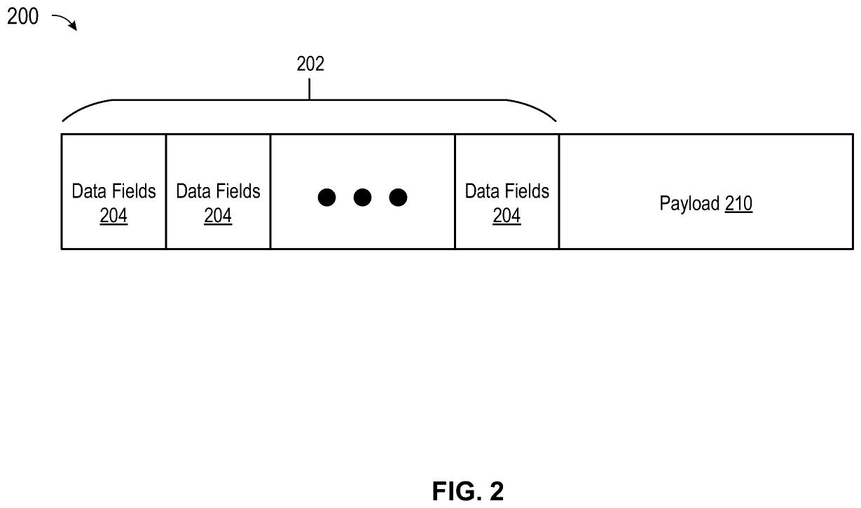

FIG. 2 is a block diagram of a frame 200 with a robust long range preamble 202. The robust long range preamble 202 can include multiple copies of data fields 204 so the receiving device can perform averaging. The data fields 204 can comprise each field of the robust long range preamble 202. In other embodiments, certain copies of the data fields 204 include a subset of the fields of the robust long range preamble 202. STAs, such as the first STA 106 and the second STA 114 can average the multiple copies of the data fields 204 to improve SNR and effectively improve the range of the wireless communication between the AP and STA. The frame 200 also includes a payload 210.

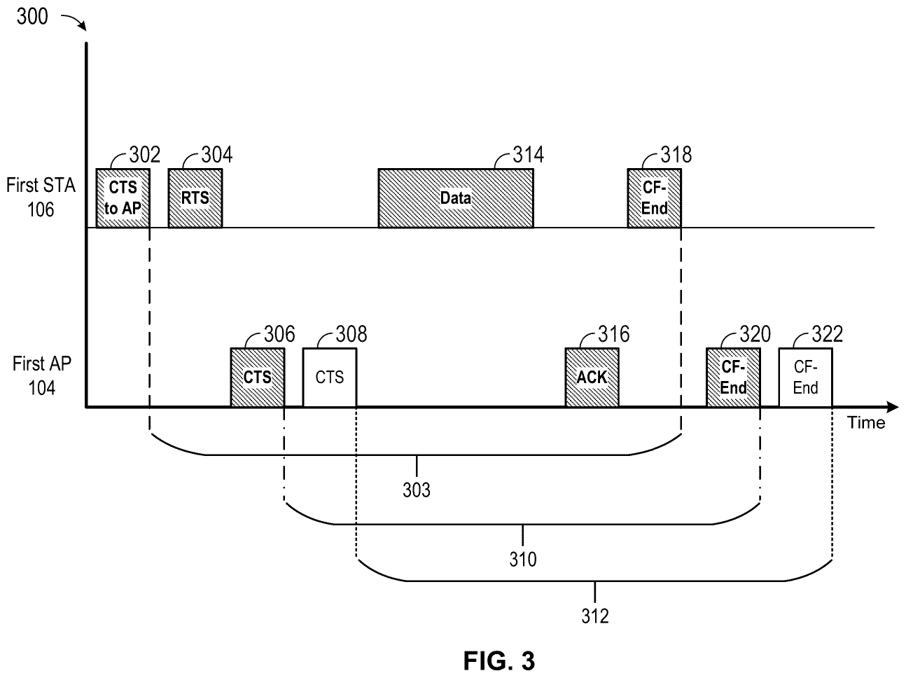

FIG. 3 is a block diagram of a signal process 300 using DRU and Dual CTS. Some legacy clients using outdated standards may not be capable of communicating using DRU. Therefore, an AP can transmit dual beacons, transmitting one beacon using DRU and transmitting one beacon without DRU, if the AP wants non-DRU capable clients to associate. In example implementations, an AP will send dual beacons by transmitting a traditional beacon first and then transmitting a second beacon using DRU after a delay. Similarly, devices can use DRU with Dual CTS to communicate, such as the via the signal process 300.

The signal process 300 can be performed by a STA and an AP, and the illustrated embodiment includes the first STA 106 and the first AP 104. The first STA 106 can optionally transmit to the first AP 104 a CTS to AP frame 302, such as to signal to legacy devices to wait before transmitting, reduce hidden node issues, and/or the like. For example, the CTS to AP frame 302 can indicate to legacy devices and/or DRU capable devices not to transmit for a first period 303. In some embodiments, the first period 303 is a Network Allocation Vector (NAV) with a duration so devices do not transmit while the first STA 106 is transmitting. The CTS to AP frame 302 may be transmitted using DRU. The first STA 106 then transmits to the first AP 104 a Request to Send (RTS) frame 304 to indicate that the first STA 106 wants to transmit to the first AP 104. The first STA 106 can transmit the RTS frame 304 using DRU in example implementations.

The first AP 104 responds to the RTS frame 304 with a first CTS frame 306 and a second CTS frame 308 to indicate that the first STA 106 can transmit and that other STAs should not transmit. The first AP 104 can transmit the first CTS frame 306 using DRU to indicate to DRU capable devices not to transmit for a second period 310, and the first AP 104 can transmit the second CTS frame 308 to indicate to legacy devices not to transmit for a third period 312. The second period 310 and the third period 312 can also be NAVs with a duration so devices do not transmit while the first STA 106 is transmitting. Thus, the first AP 104 transmits Dual CTS frames to protect period for the first STA 106 from transmissions of both DRU enabled clients and legacy clients.

The first STA 106 can to the first AP 104 then send data 314 comprising the transmissions the first STA 106 wants to send to the First AP 104. The first STA 106 can transmit the data 314 using DRU in certain embodiments. The first AP 104 responds with an acknowledge frame 316 to indicate successful reception of the data 314. The first STA 106 can then send a STA Contention Free-End (CF-End) frame 318 to indicate the end of the first period 303. The first AP 104 can transmit a first CF-End frame 320 to indicate the end of the second period 310 and a second CF-End frame 322 to indicate the end of the third period 312. DRU capable STAs and APs can therefore use the signal process 300 to suppress any non-DRU capable clients from transmitting when a DRU capable STA is communicating with the AP, such as when sending the data 314 during the first period 303, the second period 310, and the third period 312.

### Methods

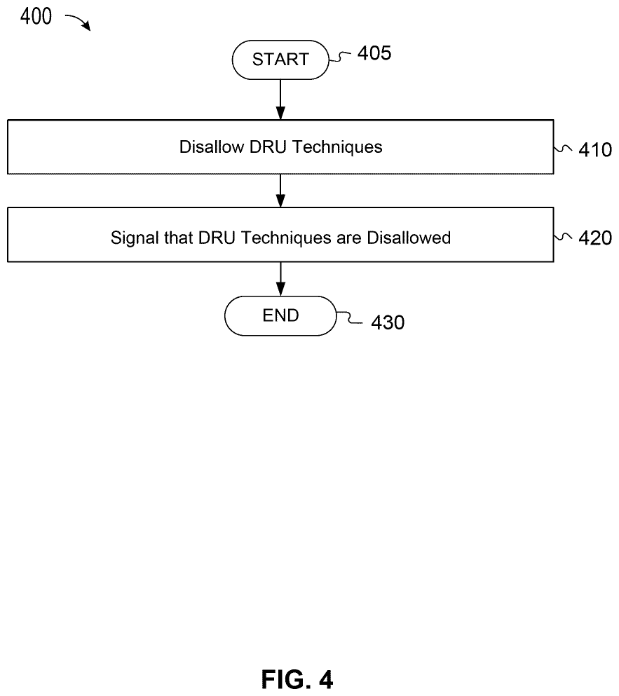

FIG. 4 is a flow chart of a method 400 for managing the implementation of DRU. The method 400 can begin at starting block 405 and proceed to operation 410. In operation 410, one or more DRU techniques are disallowed for a spectrum that has a regulatory power limitation. For example, global rules (e.g., IEEE 802.11 standards and amendments) and/or network devices disallow one or more DRU techniques. The network devices that disallow the DRU techniques can comprise the first AP 104 for the first BSS 102, the second AP 112 for the second BSS 110, and/or the controller 120 for either BSS. The one or more DRU techniques can comprise DRU beacons, DRU probe requests and DRU probe responses, DRU RTS and CTS, MU-RTS, DRU Trigger frames and other control frames, DRU for DL, UL SU DRU, and/or the like.

In operation 420, it is signaled that the one or more DRU techniques are disallowed. For example, the first AP 104 can signal to the first STA 106 and/or other network devices that the one or more DRU techniques are disallowed for communications in the first BSS 102.

The method 400 can further comprise disallowing an OFDMA PPDU that does not use a minimum percentage of energized tones of a total number of tones transmitted. In some embodiments, the method 400 comprises enabling one or more allowed DRU techniques, such as DRU for beacons, probe requests, and probe responses, a robust long range preamble 202, DL DRU, SU UL DRU, and triggered UL RU, and/or the like. In further embodiments, the method 400 comprises transmitting a traditional beacon and a second beacon using DRU.

In certain embodiments, the method 400 comprises receiving a CTS to AP frame 302 and a RTS frame 304 transmitted using DRU, transmitting a first CTS frame 306 using DRU, transmitting a second CTS frame 308, receiving data 314 transmitted using DRU, and transmitting an Acknowledge frame 316 using DRU. The method 400 can conclude at ending block 430.

### Systems

FIG. 5 is a block diagram of a computing device 500. As shown in FIG. 5, computing device 500 may include a processing unit 510 and a memory unit 515. Memory unit 515 may include a software module 520 and a database 525. While executing on processing unit 510, software module 520 may perform, for example, processes for managing the implementation of DRU and Dual CTS with respect to FIGS. 1-4. Computing device 500, for example, may provide an operating environment for first AP 104, the first STA 106, the second AP 112, the second STA 114, the controller 120, and the like. The first AP 104, the first STA 106, the second AP 112, the second STA 114, the controller 120, and the like may operate in other environments and are not limited to computing device 500.

Computing device 500 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 500 may comprise any computer operating environment, such as hand-held devices, multiprocessor systems, microprocessor-based or programmable sender electronic devices, minicomputers, mainframe computers, and the like. Computing device 500 may also be practiced in distributed computing environments where tasks are performed by remote processing devices. The aforementioned systems and devices are examples, and computing device 500 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on, or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 500 on the single integrated circuit (chip).

FIG. 6 illustrates an implementation of a communications device 600 that may implement one or more of the first AP 104, the first STA 106, the second AP 112, the second STA 114, the controller 120, etc., of FIGS. 1-4. In various implementations, the communications device 600 may comprise a logic circuit. The logic circuit may include physical circuits to perform operations described for one or more of the first AP 104, the first STA 106, the second AP 112, the second STA 114, the controller 120, etc., of FIGS. 1-4, for example. As shown in FIG. 6, the communications device 600 may include one or more of, but is not limited to, a radio interface 610, baseband circuitry 630, and/or the computing device 500.

The communications device 600 may implement some or all of the structures and/or operations for the first AP 104, the first STA 106, the second AP 112, the second STA 114, the controller 120, etc., of FIGS. 1-4, storage medium, and logic circuit in a single computing entity, such as entirely within a single device. Alternatively, the communications device 600 may distribute portions of the structure and/or operations using a distributed system architecture, such as a client station server architecture, a peer-to-peer architecture, a master-slave architecture, etc.

A radio interface 610, which may also include an Analog Front End (AFE), may include a component or combination of components adapted for transmitting and/or receiving single-carrier or multi-carrier modulated signals (e.g., including Complementary Code Keying (CCK), Orthogonal Frequency Division Multiplexing (OFDM), and/or Single-Carrier Frequency Division Multiple Access (SC-FDMA)symbols), although the configurations are not limited to any specific interface or modulation scheme. The radio interface 610 may include, for example, a receiver 615 and/or a transmitter 620. The radio interface 610 may include bias controls, a crystal oscillator, and/or one or more antennas 625. In additional or alternative configurations, the radio interface 610 may use oscillators and/or one or more filters, as desired.

The baseband circuitry 630 may communicate with the radio interface 610 to process, receive, and/or transmit signals and may include, for example, an Analog-To-Digital Converter (ADC) for down converting received signals with a Digital-To-Analog Converter (DAC) 635 for up converting signals for transmission. Further, the baseband circuitry 630 may include a baseband or PHY processing circuit for the PHY link layer processing of respective receive/transmit signals. Baseband circuitry 630 may include, for example, a MAC processing circuit 640 for MAC/data link layer processing. Baseband circuitry 630 may include a memory controller for communicating with MAC processing circuit 640 and/or a computing device 500, for example, via one or more interfaces 645.

In some configurations, PHY processing circuit may include a frame construction and/or detection module, in combination with additional circuitry such as a buffer memory, to construct and/or deconstruct communication frames. Alternatively or in addition, MAC processing circuit 640 may share processing for certain of these functions or perform these processes independent of PHY processing circuit. In some configurations, MAC and PHY processing may be integrated into a single circuit.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

1. A method comprising:
disallowing one or more Distributed Resource Unit (DRU) techniques for a spectrum that has a regulatory power limitation; and
signaling that the one or more DRU techniques are disallowed.

2. The method of claim 1, further comprising disallowing an Orthogonal Frequency-Division Multiple Access (OFDMA) PHY Protocol Data Unit (PPDU) that does not use a minimum percentage of energized tones of a total number of tones transmitted.

3. The method of claim 1, wherein the one or more DRU techniques comprises any one of: (i) DRU beacons, (ii) DRU probe requests and DRU probe responses, (iii) DRU Request to Send (RTS) and Clear to Send (CTS), (iv) Multi-User RTS (MU-RTS), (v) DRU Trigger frames and other control frames, (vi) DRU for DownLink (DL) and/or UpLink (UL) Single User (SU) DRU, or (vii) any combination of (i)-(vi).

4. The method of claim 1, wherein disallowing the one or more DRU techniques comprises following global rules.

5. The method of claim 1, further comprising enabling one or more allowed DRU techniques comprising any one of (i) DRU for beacons, probe requests, and probe responses, (ii) a robust long range preamble, (iii) DL DRU, SU UL DRU, and triggered UL DRU, or (iv) any combination of (i)-(iii).

6. The method of claim 1, further comprising:
receiving a CTS to AP frame and a RTS frame transmitted using DRU;
transmitting a first CTS frame using DRU;
transmitting a second CTS frame;
receiving data transmitted using DRU; and
transmitting an Acknowledge frame using DRU.

7. The method of claim 1, further comprising:
transmitting a traditional beacon; and
transmitting a second beacon using DRU.

8. A system comprising:
a memory storage; and
a processing unit coupled to the memory storage, wherein the processing unit is operative to:
disallow one or more Distributed Resource Unit (DRU) techniques for a spectrum that has a regulatory power limitation; and
signal that the one or more DRU techniques are disallowed.

9. The system of claim 8, the processing unit being further operative to disallow an Orthogonal Frequency-Division Multiple Access (OFDMA) PHY Protocol Data Unit (PPDU) that does not use a minimum percentage of energized tones of a total number of tones transmitted.

10. The system of claim 8, wherein the one or more DRU techniques comprises any one of: (i) DRU beacons, (ii) DRU probe requests and DRU probe responses, (iii) DRU Request to Send (RTS) and Clear to Send (CTS), (iv) Multi-User RTS (MU-RTS), (v) DRU Trigger frames and other control frames, (vi) DRU for DownLink (DL) and/or UpLink (UL) Single User (SU) DRU, or (vii) any combination of (i)-(vi).

11. The system of claim 8, wherein to disallow the one or more DRU techniques comprises to follow global rules.

12. The system of claim 8, the processing unit being further operative to enable one or more allowed DRU techniques comprising any one of (i) DRU for beacons, probe requests, and probe responses, (ii) a robust long range preamble, (iii) DL DRU, SU UL DRU, and triggered UL DRU, or (iv) any combination of (i)-(iii).

13. The system of claim 8, the processing unit being further operative to:
receive a CTS to AP frame and a RTS frame transmitted using DRU;
transmit a first CTS frame using DRU;
transmit a second CTS frame;
receive data transmitted using DRU; and
transmit an Acknowledge frame using DRU.

14. The system of claim 8, the processing unit being further operative to:
transmit a traditional beacon; and
transmit a second beacon using DRU.

15. A non-transitory computer-readable medium that stores a set of instructions which when executed perform a method executed by the set of instructions comprising:
disallowing one or more Distributed Resource Unit (DRU) techniques for a spectrum that has a regulatory power limitation; and
signaling that the one or more DRU techniques are disallowed.

16. The non-transitory computer-readable medium of claim 15, the method executed by the set of instructions further comprising disallowing an Orthogonal Frequency-Division Multiple Access (OFDMA) PHY Protocol Data Unit (PPDU) that does not use a minimum percentage of energized tones of a total number of tones transmitted.

17. The non-transitory computer-readable medium of claim 15, wherein the one or more DRU techniques comprises any one of: (i) DRU beacons, (ii) DRU probe requests and DRU probe responses, (iii) DRU Request to Send (RTS) and Clear to Send (CTS), (iv) Multi-User RTS (MU-RTS), (v) DRU Trigger frames and other control frames, (vi) DRU for DownLink (DL) and/or UpLink (UL) Single User (SU) DRU, or (vii) any combination of (i)-(vi).

18. The non-transitory computer-readable medium of claim 15, wherein disallowing the one or more DRU techniques comprises following global rules.

19. The non-transitory computer-readable medium of claim 15, the method executed by the set of instructions further comprising enabling one or more allowed DRU techniques comprising any one of (i) DRU for beacons, probe requests, and probe responses, (ii) a robust long range preamble, (iii) DL DRU, SU UL DRU, and triggered UL DRU, or (iv) any combination of (i)-(iii).

20. The non-transitory computer-readable medium of claim 15, the method executed by the set of instructions further comprising:
receiving a CTS to AP frame and a RTS frame transmitted using DRU;
transmitting a first CTS frame using DRU;
transmitting a second CTS frame;
receiving data transmitted using DRU; and
transmitting an Acknowledge frame using DRU.
